(19) United States
(12) Patent Application Publication
(10) Pub. No.: US 2007/0005989 A1
(43) Pub. Date: Jan. 4, 2007

(54) User identity privacy in authorization certificates

(76) Inventors: Claudine Viegas Conrado, Eindhoven (NL); Franciscus Lucas Antonius Johannes Kamperman, Eindhoven (NL); Geert Jan Schrijen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/549,885

(22) PCT Filed: Mar. 18, 2004
(86) PCT No.: PCT/IB04/50277

§ 371 Date: Sep. 16, 2005

(30) Foreign Application Priority Data
Mar. 21, 2003 (EP) 03100737.0

(51) Int. Cl. G06F 12/14

(52) U.S. Cl. 713/189

(57) ABSTRACT

The present invention relates to methods, devices, computer program products as well as a signal for providing privacy to a user in relation to data, which data can be a content identifier (cr_id) for identifying content. For that reason a usage right certificate (UR) generated in relation to the data, includes the data (cr_id), concealed user identifying information (for example by using (H(PK//RAN)) and random data (RAN)) enabling the verification of the user identity in the user identifying information. In this way a user is guaranteed privacy in relation to information, such as content he has purchased.

The present invention generally relates to the fields of digital access control, digital rights management, and similar fields of technology. The invention is more particularly related to providing privacy in relation to authorization certificates for digital content.

It is known to provide different types of digital authorization and access control systems over for instance the Internet where public and secret keys are used for authorization purposes. Examples of tools that can be used in such systems are SPKI (Simple Public Key Infrastructure) and SDSI (Simple Distributed Security Infrastructure).

Within the framework of SPKI it is known to use authorization certificates, which associate a public key with an authorization, where the authorization can be related to some type of informational content, and where the public key represents some entity such as a user or a device.

Authorization certificates can be used in a system for giving a user access to some content. A first user can then when using these types of systems contact a content provider and purchase or access some type of content. In the process of purchasing the first user uses a public and secret key for identifying himself and the content provider issues an authorization certificate that states that the first user has certain rights in relation to the content and is used for guaranteeing him access to the content. The certificate therefore includes some information identifying the first user. The authorization certificate is a public document, which is used by the first user and could be used by other users having a relation to this first user for accessing the content. This means that basically any person can find out about what contents or other information the first user might be interested in by checking the user identifying information in the certificate. This is a simple task if the user identifying information is a public key of the above-mentioned type. There is therefore a need for keeping the identity of a user secret in these types of certificates, while at the same time allowing the user and any possible related user access to the content in a simple manner.

In “Privacy and Accountability in Certificate Systems”, by T. Aura and C. Ellison, Helsinki University of Technology, Espoo, Finland 2000, ISBN 951-22-5000-4, ISSN 0783-5396, anonymity techniques which address threats to privacy in the context of SPKI authorization certificates are discussed. The techniques discussed consist of:

key-oriented access control, that is the idea of using public keys rather than names in the certificates,

certificate reduction, an approach in which in order to prevent the tracking of public keys in certificate chains, intermediate keys in a chain of certificates are hidden, and

temporary and task-specific keys, an approach in which the public keys of the users are changed often and new keys are created for new tasks.

The above techniques have limitations, which are discussed below.

Key-oriented access control: the use of a public key offers some degree of privacy, but this approach is limited in that a public key is a unique identifier of the user and binding a key to its owner may not be a difficult task.

Certificate reduction: this is a good solution for providing privacy with respect to the hierarchical organization of certificate chains, but there is the limitation that the key at the end of the chain cannot be hidden with reduction.

Temporary and task-specific keys: the limitation of this approach is the key management, i.e. the cost of changing and keeping track of keys, which can be a burden for users and/or certificate issuers.

There is thus a need for a solution to the above-mentioned problem of providing privacy to a user in the context of publicly accessible authorization certificates, since they associate an identity or a public key to an authorization, which the user may prefer to keep private.

It is thus an object of the present invention to provide privacy for at least one user of obtained authorizations that can be used in an access and authorization system, while at the same time allowing the proper and secure check of the user's entitlements to said authorization.

According to a first aspect of the present invention, this object is achieved by a method of associating data with users involving:

associations between
user identifying information and
data,

characterized in that
concealing data is used to conceal a user identity in the user identifying information, such that it is possible to check for a given user identity whether the association applies to it.

Data can comprise content reference identifiers, attributes, content, text, etcetera

According to a second aspect of the present invention, this object is also achieved by a method of giving a user access to information in relation to an association between a user and data including the steps of:

receiving from a user a request concerning said data using user identifying information related to the user,

retrieving the association including user identifying information that has been concealed using concealing data,

checking the concealed user identifying information in the association, and

providing the user with information related to the data based on a correspondence between the concealed user identifying information in the association and user identifying information at least linked to the user.

According to a third aspect of the present invention, this object is furthermore achieved by a device for hiding the identity of a user in an association between said user and data arranged to:

conceal user identifying information using concealing data for provision of the concealed user identifying information in the association.

According to a fourth aspect of the present invention, this object is also achieved by a device for giving a user access to information in relation to an association between a user and data arranged to:

receive a request from a user concerning said data including user identifying information relating to the user,

retrieve an association between the data and a user including user identifying information, which has been concealed using concealing data,

check the concealed user identifying information in the association, and

provide the user with information related to the data based on a correspondence between the concealed user identifying information in the association and user identifying information at least linked to the user.

According to a fifth aspect of the present invention, this object is also achieved by a device for obtaining information in relation to an association between a user and said data arranged to:

receive user identifying information related to a user that has been concealed using concealing data, and

send a request concerning said data including the concealed user identifying information,

so that an association between the user and said data comprising the concealed user identifying information can be received.

According to a sixth aspect of the present invention, this object is also achieved by a device for providing information in relation to data while concealing the identity of at least one user in relation to an association between the user and said data arranged to:

receive a request concerning said data including the user identifying information which has been concealed using concealing data, and

provide an association between the user and said data comprising the concealed user identifying information.

According to a seventh aspect of the present invention, this object is also achieved by a computer program product for giving a user access to information in relation to an association between a user and data, to be used on a computer comprising a computer readable medium having thereon:

computer program code means, to make the computer execute, when said program is loaded in the computer:

upon reception from the user of a request related to said data using user identifying information related to the user,

retrieve an association between a user and said data including user identifying information that has been concealed using concealing data,

check the concealed user identifying information in the association, and

provide the user with information related to the data based on a correspondence between the concealed user identifying information in the association and user identifying information at least linked to the user.

According to an eighth aspect of the present invention, this object is also achieved by a computer program product for hiding the identity of a user in an association between said user and data, to be used with a computer comprising a computer readable medium having thereon:

computer program code means, to make the computer execute, when said program is loaded in the computer:

conceal user identifying information using concealing data for provision of the concealed user identifying information in the association.

According to a ninth aspect of the present invention, this object is also achieved by a computer program product for providing information in relation to data while concealing the identity of at least one user in relation to an association between the user and said data, to be used with a computer comprising a computer readable medium having thereon:

computer program code means, to make the computer execute, when said program is loaded in the computer:

provide an association between the user and said data comprising user identifying information that has been concealed using concealing data.

According to a tenth aspect of the present invention, this object is also achieved by a data signal for use in relation to data and comprising an association between a user and said data, which association includes user identifying information that has been concealed using concealing data.

The dependent claims are all directed to advantageous variations of the inventive concept.

The general idea behind the invention is thus to provide an authorization certificate comprising a concealed user identifier and authorization data. This authorization certificate can then be used when the user makes use of the authorization he is entitled to.

These and other aspects of the invention will be apparent from and elucidated with reference to the embodiments described hereinafter.

Embodiments of the present invention will now be explained in more detail in relation to the enclosed drawings, where

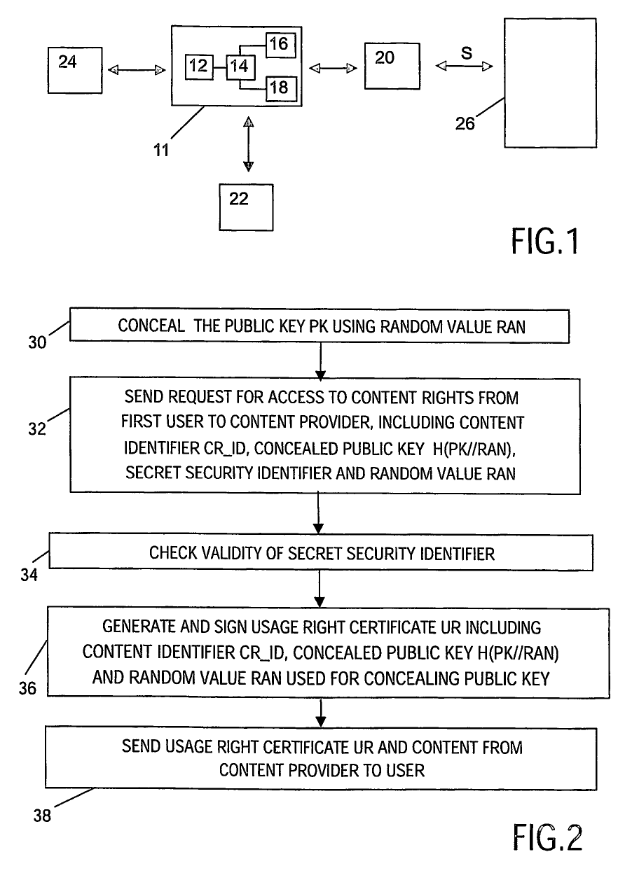

FIG. 1 shows a block schematic of a system according to the invention outlining the principles of the invention,

FIG. 2 shows a flow chart of a method of obtaining the right to content from a content provider,

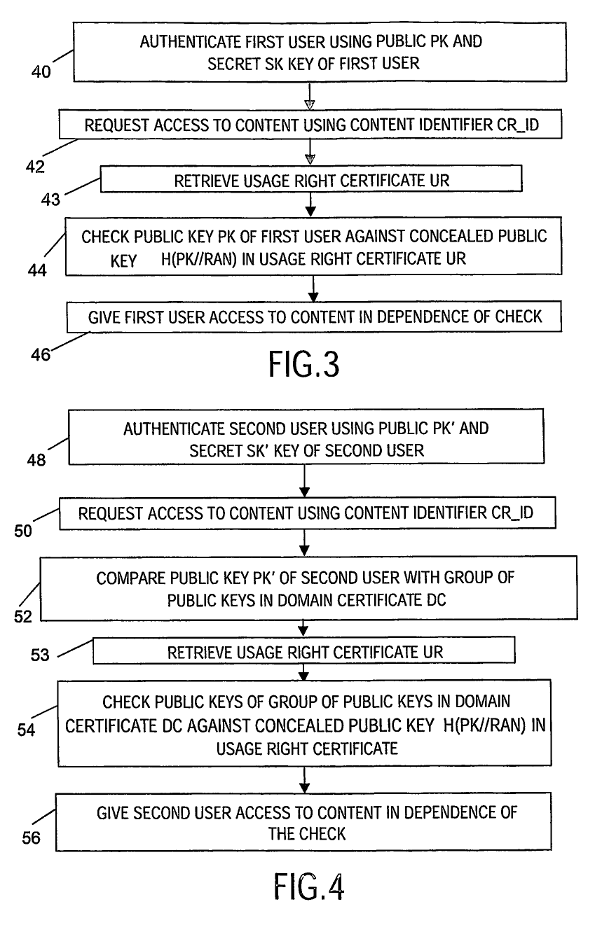

FIG. 3 shows a flow chart of a method of accessing content by a user who has obtained the right to use content,

FIG. 4 shows a flow chart of a method of accessing content by a user of a group having access to the content purchased by the first user,

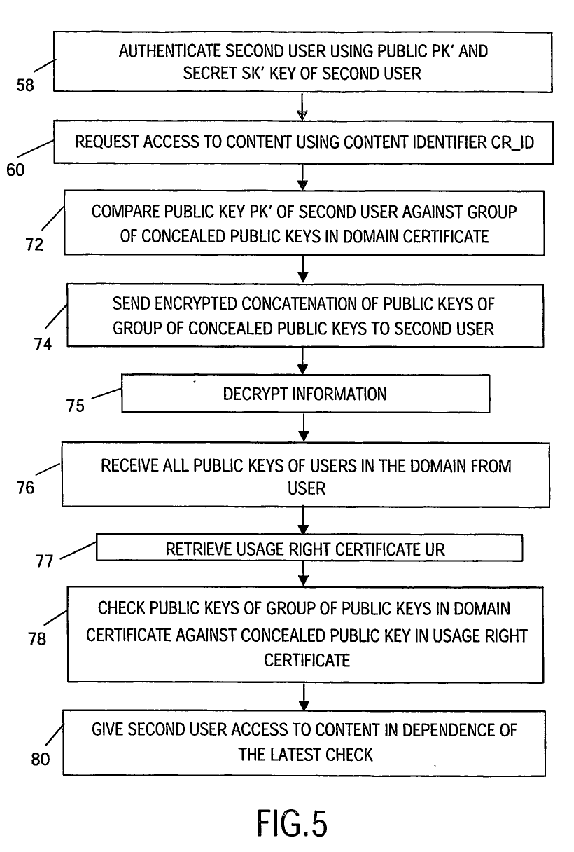

FIG. 5 shows a flow chart of a variation of the method of obtaining content by a user of a group having access to the content purchased by the first user,

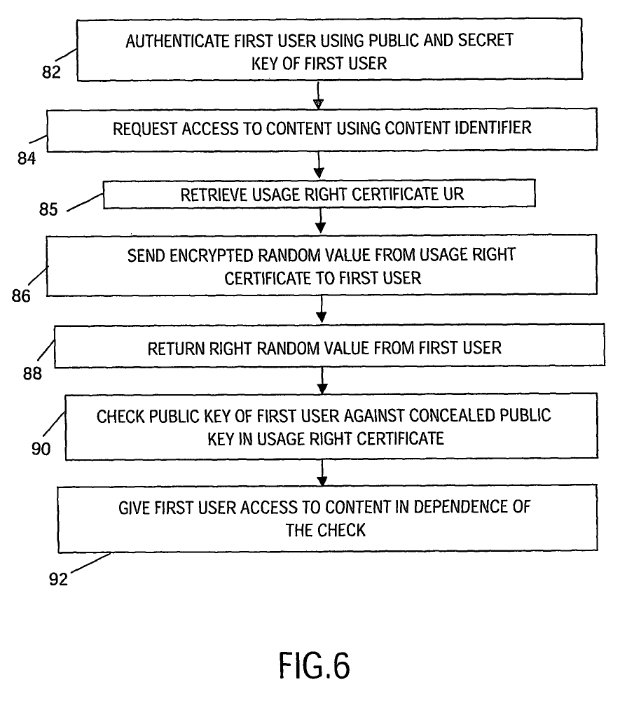

FIG. 6 shows a flow chart of a first variation of a method of accessing content by a user who has obtained the right to content,

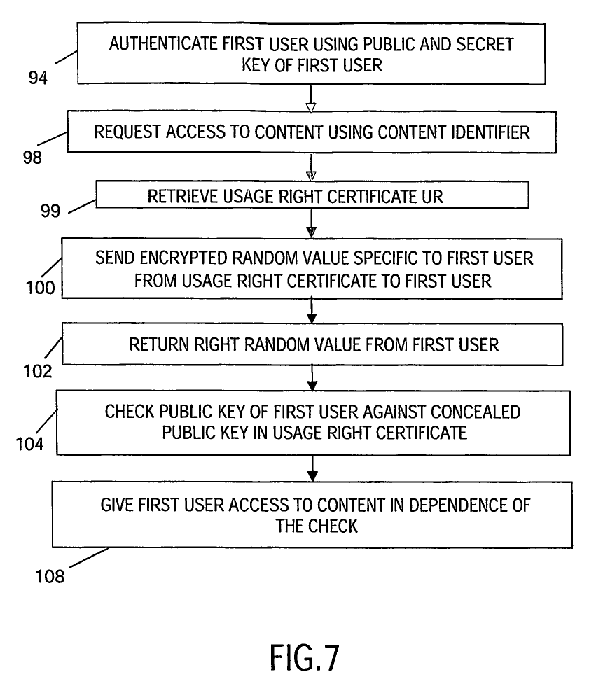

FIG. 7 shows a flow chart of a second variation of a method of accessing content by a user who has obtained the right to content,

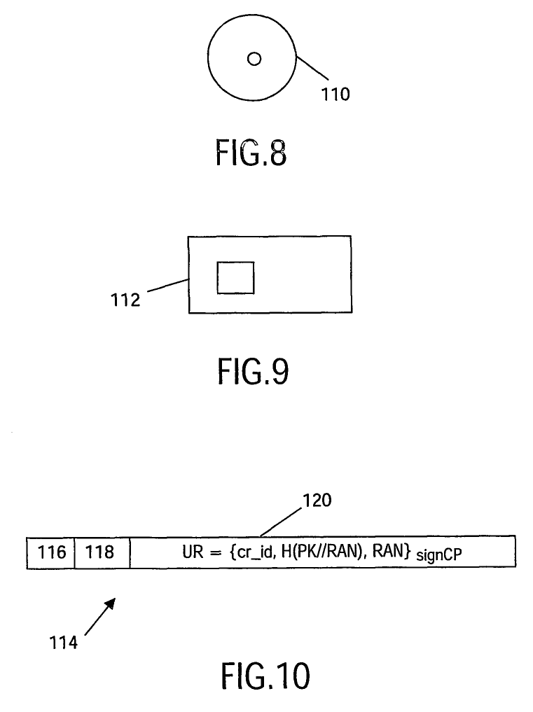

FIG. 8 schematically shows a computer readable medium in the form of a CD ROM disc including program code for performing at least parts of the invention,

FIG. 9 schematically shows a computer readable medium in the form of a smart card where certain elements of the invention are provided like encryption keys, and

FIG. 10 schematically shows a signal including a usage right certificate.

The present invention relates to the field of providing privacy for at least one user in relation to the publicly available association of their identity to data. Data can here be provided in the form of authorizations, as in the context of SPKI authorization certificates, and authorizations can here be provided, as in a first embodiment of the present invention, in the form of rights to access or ownership of data or content. In this embodiment, the content can be accessed also by a group of users in a common privacy domain. A common privacy domain can be defined using the framework of SPKI for letting several users grouped together share content obtained by each one of them. A group can for instance be a family. The grouping together of these users can in this context be done by providing a certificate including user identifying information in the form of the public keys of all the users of the group, which certificate is here called a domain certificate.

In such systems a purchaser of content can get access to the content by means of a user right certificate. Other users of the common domain, to which the purchasing user belongs, can also get access to the content through an access right function checking the usage right certificate as well as through checking the domain certificate. A usage right certificate is here a specific form of an authorization certificate in the form of a publicly known association between the user and the data or content.

FIG. 1 schematically shows a block schematic of a system including a number of public devices 22, 24 and 20 which users are using for among other things obtaining content that is coded and that can be accessed through authorization and checking of if a user has the right to the content or not. In this regard the devices are communicating with a public server 11 having a control unit 14 connected to a domain certificate store 12, to a usage right certificate store 16 and to a contents store 18. In the Figure it is also shown a content provider 26, which is accessed by the user with device 20, but which may provide content and usage right certificates directly to server 11. Its control unit 14 stores content in store 18 and usage right certificates in store 16. In order to be able to purchase and access content each user is provided with for example a smart card (not shown), which is used for authentication and encryption purposes.

It should be realized that the implementation of the system can be different than what is shown in FIG. 1. In FIG. 1 there is for instance a central content store and a central usage rights certificate store. It should be realized that usage right certificates can be provided locally in the devices of the users as well or there might be another device, which holds these certificates and content. Content and corresponding usage right certificates might furthermore be provided in different devices, which might be anywhere in a public network of devices. In this case, the content provider provides content and usage rights certificates to those different devices in the public network. The domain certificate might also be provided in some other device than the server, which can be also a public device. Moreover the devices 20, 22 and 24 can be users' devices as well as public devices.

Purchasing of some type of content will now be described in relation to FIGS. 1 and 2, where FIG. 2 shows a flow chart of a method of purchasing content. In this case each user has some user identifying information which is normally provided in the form of a public key, i.e., a key that is known or available to the whole system.

Let us first assume that a first user using a first device 20 wants to purchase some content from the content provider 26, which content can for example be an MP3-file. The first user furthermore wants to buy the content anonymously. In order to do this he uses a prepayment scheme where he buys a token with a secret security identifier on it After having done this, the first user conceals information that identifies him, which in this case is his public key PK using concealing data in the form of a random number RAN generated in his smartcard or in device 20, step 30. The act of concealing is in a preferred embodiment done by using a hash. The hash H is made on a concatenation of the user identifying information, i.e. the public key PK, and the random value RAN, which is expressed as:
H(PK//RAN)

This represents a commitment made by the first user to the value of his public key. Once this concealing has been performed using the random value, it remains fixed for reissues of that certificate. The random number RAN is also fixed and remains so for the certificate. This value RAN is also retained for every possible further anonymous reissue of the certificate in relation to purchased or obtained content. The first user then sets up an anonymous channel to the content provider and sends a request to a certain piece of content, step 32. The request includes a content identifier cr_id, the concealed public key H(PK//RAN) as well as the secret security identifier and the random value RAN. When the content provider 26 receives the request it first checks the validity of the secret security identifier and invalidates that identifier in order to prevent a double spending, step 34. Thereafter the content provider generates and signs an association between the user and data in the form of a usage right certificate UR, step 36. The usage right certificate UR then has the following content:
UR={cr_id, H(PK//RAN), RAN}_{signCP},
where signCP is the signature of the content provider.

The content provider thereafter sends the usage right certificate UR as well as the content just purchased, step 38. The content provider can send this certificate and the content directly to the device of the user, if the user requests so. In order, however, to have a central storage for those items, the provider sends the usage right UR and the content directly to the central storage server 11, from where they can be retrieved later. The usage right certificate UR is then stored in usage right store 16 of the server 11 and the content is stored in the content store 18 of the server 11. The usage right certificate is public information, but in this way there is no direct link between the public key PK of the purchaser or first user and the purchased content. Since the public key is hashed with a random value, which is different for each piece of content cr_id, the usage right certificate UR of the same public key for different pieces of content cannot be linked, and therefore a malicious party cannot find out what contents a specific user has purchased.

The anonymous channel between the first user and the provider can be implemented by means of a chain of mixes, which can provide sender anonymity (to keep the first user's anonymity) with an anonymous reply address (to provide an address to the provider to send the usage rights certificate and the content). The concept of mixes is further described in the paper “Untraceable Electronic Mail, Return Addresses and Digital Pseudonyms” by D. Chaum, Communications of the ACM, February 1981, vol. 24, no. 2, which is herein incorporated by reference.

The usage right certificate described above included the concealing data, i.e. the random value RAN. It should be realized that the concealing data could just as well be provided outside of the certificate.

How the first user later gets access to the content in the content store, which can take place using the same or another device, will now be described with reference to FIGS. 1 and 3, which latter Figure shows a flow chart of this method.

Assuming the first user is using the same device 20, the first user is first authenticated with the device 20, step 40. This is done through him proving that he, or rather his smart card, knows a secret key SK, which corresponds to his public key PK. Through this authorization the public key PK of the first user is thus disclosed to the device 20. Thereafter the first user sends a request for access to the content using the content identifier cr_id to the device 20, step 42. Device 20 then contacts control unit 14, which fetches the usage right certificate from the usage right store 16, and sends it to device 20. Device 20 checks the received public key PK of the first user against the concealed public key H(PK//RAN) in the usage right certificate UR, step 44. Since the hash function H is publicly available in the system, the device 20 can easily verify that it is the first user by running the hash function on the received public key using the random number RAN in the usage right certificate and checking the value of this just run hash function with the corresponding value in the usage right certificate UR. In dependence of this check, i.e. if the values are the same, the device 20 fetches the content from control unit 14 (which fetches it from the content store 18) and thereafter gives the first user access to the content in contents store 18, step 46.

The content is normally encrypted and the device needs to decrypt the content with a decryption key in a known fashion after the performing of the above-mentioned steps in order for the user to actually access the content.

A secure channel can be set up between the first user's smart card and the device 20, by first establishing a common secret key, for instance by using a protocol such as Diffie-Hellman, and then encrypting all subsequent communication between those two parties with that shared secret key, in order to prevent an eavesdropper from learning the public key of the first user.

Now a situation will be described in which a second user belonging to the same domain and having the right to access the content obtained by the first user accesses the content. This description is made with reference to FIGS. 1 and 4, of which the latter shows a flow chart of the method of accessing the content by the second user.

First of all it should be mentioned that the server 11 includes a domain certificate store 12, in which a domain certificate DC is stored. This domain certificate can have the format:
DC={PK, PK′, PK″, . . . },_{signTTP},
Where PK, PK′ and PK″ indicate public keys of the first user, the second user and a third user, respectively. The expression signTTP indicates the signature of a trusted third party on the certificate, such as the community administration. The domain certificate is also publicly available in the whole domain.

The second user can for instance be using device 22. The second user is first authenticated with the device 22, step 48. This is done through him proving that he, or rather his smart card, knows a secret key SK′, which corresponds to his public key PK′. Through this authorization the public key PK′ of the second user is thus disclosed to device 22. Thereafter the second user sends a request for access to the content using the content identifier cr_id to the device 22, step 50. When device 22 receives this request, it contacts control unit 14, which fetches or retrieves the domain certificate DC from the domain certificate store 12 and sends it back to device 22. It then compares the public key PK′ against a group of public keys in the domain certificate DC, step 52. Here it compares the public keys such that it can determine that the public key PK′ of the second user is grouped together with a number of other public keys in the domain. The device 22 also retrieves the usage right certificate UR from the usage right store 16, step 53, via a request to the control unit 14, and checks all the public keys of the group against the concealed public key H(PK//RAN) in the usage right certificate UR, step 54. This check for all public keys is performed in the same way as was described for public key PK in relation to FIG. 3. In dependence of this check, i.e. if any of the public keys correspond to the concealed public key in the usage right certificate UR, the device 22 thereafter gives the second user access to the content in contents store 18, step 56.

In this way it is guaranteed that other users of the domain are allowed access to the content, while at the same time allowing privacy to the first user.

The above described scheme for checking the public keys of the domain certificate is working well for small systems, i.e. where there are not too many users. In case the system gets bigger it is however burdensome to find the public key of the first user in the domain certificate. In order to ease the search, the usage right certificate is in an alternative embodiment provided with an index indicating the public key of the purchaser, i.e. the public key PK of the first user. In one variation of the invention this index is made up of the few or first number of bits of the public key of the purchasing user. In this way only public keys, which have these number of bits in common are searched, which makes the processing faster. This solution has the slight disadvantage of giving up some of the privacy of the public key of the purchasing, i.e. first user.

As stated above, the domain certificate is public. When the usage right is stored together with this domain certificate as is shown in FIG. 1, a malicious party or attacker has all the public keys available to him and can then find out which user has purchased a certain content. In order to avoid this problem, the domain certificate DC can be provided in an alternative form given below.
DC={H(PK), H(PK′), H(PK″), . . . , SK_{D1}[PK//PK′ . . . ]}_{signTTP},
Where SK_{D1} is a first secret domain key shared by the domain members or the users of the domain and stored in their smart cards. The users in the domain generate it without any interference from the content provider, in order to provide privacy. H is here again a known hash function, while SK_{D1}[PK//PK′ . . . ] denotes the encryption of the concatenation of all the public keys in the domain using the first shared secret domain key. This allows each user of the domain to retrieve the public keys.

An alternative way for a second user to access the content will now be described with reference to FIGS. 1 and 5, which latter Figure shows a variation of the method in FIG. 4.

The second user is again using device 22. The second user is first authenticated with the device 22, step 58, and thereby the public key PK′ of the second user is disclosed to the device 22. Thereafter the second user sends a request for access to the content using the content identifier cr_id to the device 22, step 60. When the device 22 receives this request it fetches the domain certificate DC from the domain certificate store 12 via the control unit 14 and compares the public key PK′ against a group of concealed public keys in the certificate DC, step 72. Here the device 22 performs the known hash function H on the received public key PK′ and finds the corresponding hash value in the domain certificate DC. Thereafter the device 22 sends the encrypted concatenation of all the public keys in the domain SK_{D1}[PK//PK′ . . . ] to the second user or rather to the smart card of the second user, step 74. The smart card of the second user decrypts this information in order to obtain the public keys of the users in the domain, step 75. Thereafter the device 22 receives all the decrypted public keys in the domain from the second user, step 76. Similar to what was described earlier, the device 22 then retrieves the usage right certificate UR, step 77, and thereafter the steps of checking and giving access, steps 78 and 80, are performed.

There exists another way to prohibit a malicious user or attacker to find out what content a certain user has purchased, when the usage right certificate is stored together with the domain certificate, which makes all the public keys available to the attacker as described above. This other solution to this problem is to provide the random value in the usage right certificate encrypted.

A modified usage right certificate would then have the following structure:
UR={cr_id, H(PK//RAN), SK_{D2}[RAN]}_{signCP},
where the random value RAN is encrypted using a second secret domain key SK_{D2} stored in the smart cards of the users and shared by all the domain members. The value RAN is as mentioned previously the random value selected by the first user when purchasing the content. In case the value RAN is not provided in the usage right certificate, this encryption would of course not be necessary to include in the certificate, but might be provided outside of the certificate if it is needed.

When the first user purchases the content, the method described in FIG. 2 is adjusted slightly so that the user has to encrypt the selected random value RAN with the key SK_{D2} in the smart card and also send this encrypted value in the request. The content provider then also includes this encrypted random value in the generated usage right certificate.

In order to provide access to the content for the first user, reference is now being made to FIGS. 1 and 6, which latter Figure shows a flow chart of a first variation of the method shown in FIG. 3.

Under the same assumption that the first user is using the device 20, the first user is first authenticated with the device 20 in the previously described manner, step 82, such that the public key PK of the first user is disclosed to the device 20. Thereafter the first user sends a request for access to the content using the content identifier cr_id to the device 20, step 84. When the device 20 receives this request it fetches or retrieves the usage right certificate UR from the usage right store 16 via the control unit 14, step 85, and sends the encrypted random value SK_{D2}[RAN] to the first user, step 86. This value is provided to the smart card of the user, which decrypts the value and returns the now unencrypted value RAN to the device 20, step 88. As the device 20 now has the decrypted value RAN, it can continue with the steps of checking public key against concealed public key in the usage right certificate, step 90, and providing the first user with access to the content, step 92, in the same way as was described in relation to FIG. 3.

When a second user is granted access to the content based on this random number encryption, the method described in FIG. 4 can be used instead of the longer method described in FIG. 5. The method described in FIG. 4 then has to be modified slightly so that the encrypted random value is sent to the smart card of the second user for decryption before the step of checking public keys in the domain certificate against the concealed public key in the usage right certificate is performed. The method in FIG. 5 can of course also be used, but it does not add any additional security and thus only complicates the authentication of other users in the group.

There is yet another aspect of the present invention which has to be addressed, and that is the problem of privacy, when the users in the domain are changed, by adding or deleting members.

When the members of the domain are changed, the domain certificate has to be changed or replaced, stating the new membership relations of public keys to the domain. Also usage right certificates may have to be replaced if they include the term SK_{D2}[RAN].

When a new user enters the domain without bringing any own usage rights with him, he must get access to the secret domain keys SK_{D1} and SK_{D2} in the cases where they are used. This is done in order for him to access content owned by other domain members. Naturally he also has to have a public/secret key pair, where the public key also has to be provided in the new domain certificate.

When a person leaves a domain without taking any usage rights with him, he can no longer access any content belonging to other users of the domain, provided the domain certificate is updated properly. He will however still have at least the second secret domain key SK_{D2}, which he can use to calculate RAN with. This means that the privacy is no longer guaranteed regarding this leaving user. The solution to this problem is to change the second secret domain key after the user leaves the domain and issue new usage right certificates with the new key. The old key must however be stored in order for the old usage rights certificates to be valid. Eventually new version of old usage right certificates will have to be issued with the new second secret domain key.

If a leaving user takes his usage rights with him also the second secret domain key of the leaving user SK_{D2} should be changed for the same above described reasons.

If an entering user brings his usage rights with him, again he must get access to the secret domain keys SK_{D1} and SK_{D2} in the cases where they are used. The entering user's usage rights must be re-issued with the secret domain key SK_{D2} in order for the users in the domain to be able to use the entering user's usage rights.

There is thus a need for re-issuance of certificates in the special case when the domain certificate membership changes in order to guarantee privacy and the rightful access to content to the users entitled to the content.

When re-issuing certificates with a new second secret domain key care has to be taken that a certificate of one user in the domain is not wrongfully assigned to another user.

With a usage right certificate of the form:
UR={cr_id, H(PK//RAN), SK_{D2}[RAN]}_{signCP},
the content provider is able to check that the value of the public key does not change without having to see the public key PK. This is due to the fact that the hash function will have the same value in a new certificate and because no other combination using other public keys will give the same hash value.

The way a certificate is reissued is performed in the following way. The content owner sends, through an anonymous channel, a request for reissuing a certificate including the old certificate UR={cr_id, H(PK//RAN), SK_{D2}[RAN]}_{signCP} together with a new value SK′_{D2}[RAN]. RAN is here the same random value in both cases. The content provider checks the correctness of the old usage right certificate and then creates a new certificate where SK_{D2}[RAN] has been replaced by SK′_{D2}[RAN].

If a user leaves a domain and takes his owned content with him but does not bring with him the secret domain key SK_{D2}, he still needs to get access to the content. This is achieved by providing a variation of the usage right certificate according to the following:
UR={cr_id, H(PK//RAN), SK_{D2}[RAN], SKₚ[RAN],}_{signCP},
where SKₚ is a secret personal key of the user purchasing content and only provided in the smart card of the purchasing user. This secret personal key is used to encrypt the random value RAN in a similar way to the encryption using the second secret domain key. In case the value RAN is not provided in the usage right certificate, this encryption would of course not be necessary to include in the certificate, but might be provided outside of the certificate if it is needed.

The way the content is purchased or obtained is generally performed in the same way as was described in relation to FIG. 2, but with the addition that the user encrypts the random value RAN using the secret personal key and encloses it in the request and the content provider then includes the encrypted random value together with the rest of the items in the usage right certificate.

The allowing of access to the usage right certificate to the first user who originally purchased the content after leaving the domain will now be briefly described in relation to FIG. 7.

The first user is first authenticated with a device in the previously described manner, step 94, such that the public key PK of the first user is disclosed to the device. Thereafter the first user sends a request for access to the content using the content identifier cr_id, step 98. When the device receives this request it fetches or retrieves the usage right certificate UR from the usage right store 16 via the control unit 14, step 99, and sends the encrypted random value SK_{P}[RAN] to the first user, step 100. This value is provided to the smart card of the user, which decrypts the value and returns the now unencrypted value RAN to the device, step 102. As the device now has the decrypted value RAN, it can continue with the steps of checking public key against concealed public key in the usage right certificate, step 104, and providing the first user with access to the content, step 108, in the same way as was described previously. In this way a user leaving the domain can still access content purchased by him, which content is still attached to the domain.

There are a number of further variations that can be made to the present invention. A usage right certificate can have an alternative form, when a different type of concealing function is used for concealing the user identity, i.e. the public key. This form is the following:
UR={cr_id, RAN[PK], SK_{D2}[RAN]}_{signCP},
Where RAN[PK] denotes the encryption of the value PK using the value RAN. Naturally the above described methods where H(PK//RAN) has been used in combination with SK_{D2}[RAN] have to be replaced with RAN[PK].

Another possible variation is to encrypt the public key PK using the secret domain key SK_{D2} instead of using the random number RAN.

The concealing of the public key makes it difficult for devices to find the correct usage right certificate when a user has authenticated himself and asked for content using cr_id. In order to solve this a value SK_{D2}[cr_id] is included in the usage right certificate. This value is basically an index that is calculated by means of the second secret domain key, but also the first secret domain key can possibly be used. What happens after authentication and when requesting content is that any of the users requesting access can calculate the indexing value and send it to the corresponding device. The device can now perform a search on the fields cr_id and SK_{D2}[cr_id] and retrieve the correct usage right certificate.

Another possible variation is to provide the usage right certificate with an extra field, a so-called rights attributes data field. A usage right certificate including such a field, as used in relation to the description related to FIG. 2-7, would then have one of the following structures:
UR={cr_id, r_d, H(PK//RAN), RAN}_{signCP},
UR={cr_id, r_d, H(PK//RAN), SK_{D2}[RAN]}_{signCP} or
UR={cr_id, r_d, H(PK//RAN), SK_{D2}[RAN], SKₚ[RAN],}_{signCP},
where r_d indicates this rights attributes data field. The field is included in the usage right certificate by the content provider upon the anonymous buying of the rights by the user, and it indicates the rights a user has concerning the usage of the content. It may for instance indicate that the user is only allowed to watch the content up until a certain date or time. Such types of conditions on the usage of content are chosen by the user upon the buying of the usage rights, according to options of usage, which are provided by the content provider. The payment of the usage rights is obviously done according to the option chosen by the user. It should also be realized that this field can also be used in combination with all the previously described embodiments and variations of the present invention.

The identity of the user in relation to the usage right certificate has in the description above been made with reference to a public key. It should be realized that the invention is in no way limited to public keys. Any type of user identifying information can be used such as a name, biometrics data or some other type of identity. In the same manner the data to which the user is associated has been described in relation to an identifier for purchased content. The data is not limited to this, but can be any type of data, such as user attributes like age or gender or any type of authorization. The description was also made in relation to the access to content, but the information related to the data can also be such things as a list of preferences associated with the user.

The server and different devices in the domain are normally provided in the form of computers or devices having computing capabilities having processors and associated program memories for storing the program code. The different stores in the server are also provided in the form of memories. The functions for performing the invention are then preferably provided as program code in such memories. The program code for the devices for the users can also be provided in the form of one or more CD ROM discs which perform the functions of the invention when being loaded into a program memory, of which one 10 is shown in FIG. 8. A lot of the functionality related to the users is strongly linked to the user having a smart card, where keys and decryption functions are provided. In this case these smart cards can also have program code stored on them form performing the user related parts of the methods described above. A smart card reader having a smart card loaded into it, can then also be seen as being a computer. One such smart card 112 is schematically shown in FIG. 9.

The usage right certificate is also transmitted from both the content provider to the server 11 as well as between the server and the devices. FIG. 10 schematically shows one such data signal 114, having a header including a destination address field 116 and a source address field 118 as well as a payload 120 including the usage right certificate UR={cr_id, H(PK//RAN), RAN}_{signCP}.

The present invention has many advantages. It allows a greater degree of privacy while at the same time allowing rightful users to access content from anywhere in a public network of devices, with the proper and secure checks of the access rights for the content. The invention also relieves the content providers the burden of generating many usage right certificates for the same content to the same buyer over and over again, as in the approach of temporary public keys.

1. A method of associating data with users involving
associations between
user identifying information and
data,
characterized in that
concealing data is used to conceal a user identity in the user identifying information, such that it is possible to check for a given user identity whether the association applies to it.

2. The method according to claim 1, wherein the user identity is concealed using a hash function.

3. The method according to claim 1, wherein the user identity is concealed using encryption.

4. The method according to claim 1, wherein the concealing data comprises a random value.

5. The method according to claim 1, wherein the associations are publicly available.

6. The method according to claim 1, further comprising the step of providing an association.

7. The method according to claim 1, further comprising
the step of receiving a request for an association, and
the step of providing the association.

8. The method according to claim 6, further comprising the step of signing the provided generated association.

9. The method according to claim 7, wherein the request includes the user identifying information in which the user identity is concealed (step 32) using concealing data.

10. Method according to claim 1, wherein the concealing data is encrypted by a secret user key.

11. Method according to claim 1, wherein said concealing data remains fixed for reissued associations.

12. Method according to claim 1, wherein the association is a digital certificate.

13. Method according to claim 12, wherein the digital certificate is an SPKI authorization certificate.

14. Method according to claim 12, wherein the association includes the right to access purchased digital content.

15. Method according to claim 1, wherein the association comprises a content identifier.

16. Method according to claim 1, wherein the association comprises a rights attributes data field.

17. Method according to claim 1, wherein the association includes an index indicating the right user identifying information associated with the user.

18. Method according to claim 1, further comprising the step of sending a request in relation to said data including the concealed user identifying information (step 32).

19. Method according to claim 18, wherein the request includes the concealing data in order to enable revealing of the user identifying information.

20. Method according to claim 18, wherein the request further includes a secret security identifier.

21. Method according to claim 18, further including the step of encrypting the concealing data by using a secret domain key, such that the concealing data is encrypted in at least the request.

22. Method of giving a user access to information in relation to an association between a user and data including the steps of:
receiving from a user a request concerning said data using user identifying information related to the user, (steps 42; 50; 60; 98; 84),
retrieving the association including user identifying information that has been concealed using concealing data, (steps 43; 53; 77; 85; 99),
checking the concealed user identifying information in the association, (steps 44; 54; 78; 90; 104), and
providing the user with information related to the data, (steps 46; 56; 80; 92; 108) based on a correspondence between the concealed user identifying information in the association and user identifying information at least linked to the user.

23. Method according to claim 22, wherein the step of providing the user with information comprises providing the user access to content corresponding to said data, (steps 46; 56; 80; 92; 108).

24. Method according to claim 22, further including the step of performing authentication of the user (steps 40; 48; 58; 82; 94).

25. Method according to claim 22, wherein the user identifying information received from the user is the same as the user identifying information in the association and the step of providing is based on a correspondence between the concealed user identifying information and the user identifying information received from the user.

26. Method according to claim 22, wherein the user identifying information received from the user is different than the user identifying information in the association and further including the step of:
comparing the user identifying information of the user against a user domain certificate including user identifying information related to all users in a domain, (steps 52; 72),
wherein the step of checking concealed user identifying information in the association with user identifying information (steps 54; 78) is performed on user identifying information in the domain certificate, and
the step of providing (steps 56; 80) is performed based on a correspondence between the concealed user identifying information in the association and any user identifying information in the domain certificate.

27. Method according to claim 26, wherein the domain certificate includes concealed user identifying information of all the users in the domain and an encryption of a concatenation of all user identifying information in the domain using a secret domain key.

28. Method according to claim 27, further including the steps of sending the encrypted concatenation of all user identifying information to the user (step 74) and receiving identifying information about all users in the domain from said user (step 76).

29. Device (112) for hiding the identity of a user in an association between said user and data arranged to:
conceal user identifying information using concealing data for provision of the concealed user identifying information in the association.

30. Device (20, 22, 24) for giving a user access to information in relation to an association between a user and data arranged to:
receive a request from a user concerning said data including user identifying information relating to the user,
retrieve an association between the data and a user including user identifying information, which has been concealed using concealing data,
check the concealed user identifying information in the association, and
provide the user with information related to the data based on a correspondence between the concealed user identifying information in the association and user identifying information at least linked to the user.

31. Device (20, 22, 24) for obtaining information in relation to an association between a user and said data arranged to:
receive user identifying information related to a user that has been concealed using concealing data, and
send a request concerning said data including the concealed user identifying information,
so that an association between the user and said data comprising the concealed user identifying information can be received.

32. Device (26) for providing information in relation to data while concealing the identity of at least one user in relation to an association between the user and said data arranged to:
receive a request concerning said data including the user identifying information which has been concealed using concealing data, and
provide an association between the user and said data comprising the concealed user identifying information.

33. Computer program product (110) for giving a user access to information in relation to an association between a user and data, to be used on a computer comprising a computer readable medium having thereon:
computer program code means, to make the computer execute, when said program is loaded in the computer:
upon reception from the user of a request related to said data using user identifying information related to the user,
retrieve an association between a user and said data including user identifying information that has been concealed using concealing data,
check the concealed user identifying information in the association, and
provide the user with information related to the data based on a correspondence between the concealed user identifying information in the association and user identifying information at least linked to the user.

34. Computer program product (112) for hiding the identity of a user in an association between said user and data, to be used with a computer comprising a computer readable medium having thereon:
computer program code means, to make the computer execute, when said program is loaded in the computer:
conceal user identifying information using concealing data for provision of the concealed user identifying information in the association.

35. Computer program product (110) for providing information in relation to data while concealing the identity of at least one user in relation to an association between the user and said data, to be used with a computer comprising a computer readable medium having thereon:
computer program code means, to make the computer execute, when said program is loaded in the computer:
provide an association between the user and said data comprising user identifying information that has been concealed using concealing data.

36. A data signal (114) for use in relation to data (cr_id) and comprising an association between a user (PK) and said data, which association (UR) includes user identifying information (PK) that has been concealed using concealing data (RAN).
